(19) United States
(12) Patent Application Publication
(10) Pub. No.: US 2015/0015975 A1
(43) Pub. Date: Jan. 15, 2015

(54) HELIOSTATS, AND METHODS AND APPARATUS FOR ASSEMBLY THEREOF

(71) Applicant: BRIGHTSOURCE INDUSTRIES (ISRAEL) LTD., Jerusalem (IL)

(72) Inventors: Shmuel Huss, Jerusalem (IL); Zeev Shvets, Modiin (IL); Rotem Baavour, Regavim (IL); Mark Slutsky, Jerusalem (IL); Natan Klugman, Jerusalem (IL); Nadav Bar Or, Mevaseret Zion (IL); Gilad Meller, Beit Zayit (IL)

(73) Assignee: Brightsource Industries (ISRAEL) Ltd., Jerusalem (IL)

(21) Appl. No.: 14/380,347

(22) PCT Filed: Feb. 28, 2013
(86) PCT No.: PCT/IB2013/051601

§ 371 Date: Aug. 21, 2014

Related U.S. Application Data
(60) Provisional application No. 61/653,881, filed on May 31, 2012.

(30) Foreign Application Priority Data
Mar. 1, 2012 (CN) 201220073831.8
Jun. 4, 2012 (CN) 201220261118.6
Jul. 26, 2012 (CN) 201220366141.1
Aug. 1, 2012 (CN) 201220379027.2
Dec. 27, 2012 (CN) 201220734120.0

(51) Int. Cl. G02B 7/183; G02B 19/00

(52) U.S. Cl. CPC G02B 7/183; G02B 19/0019; G02B 19/0042
USPC 359/853; 29/428

(57) ABSTRACT

A solar energy collection system can include a plurality of heliostats configured to reflect sunlight to a target mounted on a tower. Each of the heliostats can include (i) a mirror assembly, which can include at least one mirror, at least one support arm and a pair of diagonals attached to each end of the support arm, the support arm attached to the backside of the mirror along its entire length, (ii) an elongated central support element, (iii) at least one connecting element configured to attach the mirror assembly to the elongated central support element. The location of attachment points on the at least one connecting element can define the curvature of the mirror in at least one dimension.

### CROSS-REFERENCE TO RELATED APPLICATIONS

The present application claims the benefit of Chinese Utility Model Patent CN201220073831.8, filed Mar. 1, 2012, Chinese Utility Model Patent CN201220261118.6, filed Jun. 4, 2012, Chinese Utility Model Patent Application CN201220366141.1, filed Jul. 26, 2012, Chinese Utility Model Patent CN201220379027.2, filed Aug. 1, 2012, Chinese Utility Model Patent Application CN201220734120.0, filed Dec. 27, 2012, and U.S. Provisional Application No. 61/653,881, filed May 31, 2012, which are incorporated by reference herein in its entirety.

### FIELD

The present disclosure relates to central tower power plants, and in particular, to heliostats designed for use therewith and especially to components thereof. The disclosure also relates to methods and apparatus for assembly of the heliostats.

### SUMMARY

Suppliers of energy are increasingly seeking alternative sources of energy. One such source of energy is solar energy and one way of utilizing solar energy is with a central tower power plant.

A typical central tower power plant installation comprises an array of heliostats and a tower. Each of the heliostats is configured to track the sun and reflect sunlight toward a receiver or other target on the tower, where the solar energy is converted to another form of energy such as heat or electricity.

Embodiments of the present disclosure relate to a method of assembling heliostats, including the steps of attaching at least one support arm to a non-reflective face of a mirror, attaching a first end of each of a pair of diagonals to each support arm and folding each diagonal so as to be substantially flush with and parallel to the support arm. In some embodiments the support arm may be attached to the non-reflective face of the mirror with an adhesive. The support arms may be U-shaped and each of the diagonals may folds into a groove of the U-shape. Alternatively, the diagonals may be U-shaped and each of the diagonals cover at least a portion of the support arm when folded down. The method of assembling heliostats may further include the step of stacking a plurality of mirrors with attached support arms and respective pairs of diagonals, forming a stack with a thickness that is equal to the number of stacked mirrors multiplied by the sum of the thickness of a mirror and the greater of the thicknesses of the attached support arm and of the attached pair of diagonals.

The method may further include the step of attaching at least one of an azimuth drive and an elevation drive to a torque tube thereby forming a torque tube subcomponent. The torque tube subcomponent may then be attached to a second end of each of the pair of diagonals.

Embodiments of the present disclosure relate to a method of assembling heliostats including the steps of unfolding each of a pair of diagonals so as to extend them outwardly from a support arm, attached to the non-reflective face of a mirror and attaching a second end of each of the pair of diagonals to a torque tube or torque tube subcomponent. In some embodiments, the step of attaching includes securing at least one of the support arm and the second end of each of the pair of diagonals to a connecting element, which is positioned to be in contact with the torque tube, thereby forming a reflection unit. The reflection unit may then be attached to a pylon. The attachment point of the second end of each pair of diagonals defines the curvature of the mirror. At least two mirrors may be attached to the torque tube subcomponent. In some embodiments, the method further includes the step of attaching a power control module to the mirror, the power control module may be connected to a photovoltaic panel.

Embodiments of the present disclosure relate to a mirror-bearing heliostat including a mirror assembly which may include at least one mirror, at least one support arm and a pair of diagonals for each support arm attached thereto, an elongated central support element and at least one connecting element configured to attach the mirror assembly to the elongated central support element. The location of attachment points on the at least one connecting element may define the curvature of the mirror in at least one dimension. The elongated support element may be a hollow tube. The heliostat may bear at least two mirrors. In some embodiments, the attached support arm, pair of diagonals and the connecting element form a truss.

Embodiments of the present disclosure relate to a solar field of at least 100 heliostats. Each heliostat may be configured to pivot on two axes and each heliostat including a mirror assembly, each of which comprises a mirror at least one support arm and a pair of diagonals for each support arm attached thereto and a crosswise member comprising a hollow tube and a plurality of connecting elements, the crosswise member joining at least two of the mirror assemblies and configured to be a pivot for one of the two axes. In a first subset of heliostats the mirror assemblies may attached to the crosswise member at a set of attachment points in a first location on a connecting element, and in a second subset of heliostats the mirror assemblies are attached to the crosswise member at a set of attachment points in a second location on a connecting element, the heliostats being configured so that the location of the attachment points on the connecting elements defines the curvature of the mirror in at least one dimension. The attachment of the mirror assembly to the crosswise member forms a truss.

Embodiments of the present disclosure relate to a mirror assembly for a heliostat including (i) a mirror with a front reflective face and a back non-reflective face, (ii) at least two support arms attached to the non-reflective face of the mirror and having a height normal to the plane of the non-reflective face of the mirror and (iii) a pair of diagonals, each having a height for each of the at least two support arms wherein a proximal end of each diagonal is attached to one of the support arms and each diagonal is configured to be folded so as to be substantially parallel with the support arm. The combined height of the support arm and the folded pair of diagonals may be substantially the same as that of the one with the greater height. In some embodiments, the diagonals may be configured to collapse into the groove of the support arm and the support arm height is greater than the diagonal height. In another embodiment, the diagonals may be configured to cover the support arm and the diagonal height is greater than the support arm height. A distal end of the diagonal may be configured to be attached to an elongated central support element or a connecting element attached thereto.

Embodiments of the present disclosure relate to a modular heliostat assembly apparatus. The assembly may include (i) a receptacle for loaded mirrors, the loaded mirrors having at least one support arm and a pair of diagonals for each support arm attached thereon, (ii) a receptacle for torque tube assemblies and (iii) an assembly station for attaching torque tube assemblies to the loaded mirrors. In some embodiments the modular heliostat assembly apparatus may also include a receptacle for torque tubes and an assembly station for attaching torque tubes to azimuth drives and/or elevation drives, creating the torque tube assemblies. In further embodiments, the modular heliostat assembly apparatus may include an assembly station for attaching a power control module to the loaded mirrors. A plurality of modular heliostat assembly apparatuses may be served by a single source of at least one of the utilities comprising electrical power, compressed air and water. Each of the plurality of modular heliostat assembly apparatuses may be configured to be assembled from, or transported as, skid-mounted elements.

### BRIEF DESCRIPTION OF THE DRAWINGS

Embodiments will hereinafter be described with reference to the accompanying drawings, which have not necessarily been drawn to scale. Where applicable, some features may not be illustrated to assist in the illustration and description of underlying features. Throughout the figures, like reference numerals denote like elements.

FIG. 1A-1C show a mirror assembly which includes a mirror, support arms and diagonals, according to one or more embodiments of the disclosed subject matter.

FIG. 2A-2B show a perspective view of two examples of a reflection unit, which includes a mirror assembly—as shown in FIG. 1—and a torque tube and connectors, according to one or more embodiments of the disclosed subject matter.

FIG. 3A-3C show components of a torque tube including a number of potential attachment points on A-plates and U-bars, according to one or more embodiments of the disclosed subject matter.

FIG. 4 shows a reflection unit, according to one or more embodiments of the disclosed subject matter.

FIG. 5 shows is a side view of a support arm, according to one or more embodiments of the disclosed subject matter.

FIG. 6 shows a perspective view of an example of a support arm, according to one or more embodiments of the disclosed subject matter.

FIG. 7 shows a perspective view of an example of a diagonal, according to one or more embodiments of the disclosed subject matter.

FIG. 8A shows a perspective view of a connector as part of the reflection unit, according to one or more embodiments of the disclosed subject matter.

FIG. 8B is an exploded view of the connector illustrated in FIG. 8A, according to one or more embodiments of the disclosed subject matter.

FIG. 8C is a perspective view of a connector as part of the reflection unit according to one or more embodiments of the disclosed subject matter.

FIG. 8D is an exploded view of a connector illustrated in FIG. 8C, according to one or more embodiments of the disclosed subject matter.

FIG. 9 is a bottom view of a modification of a mirror with only support arms attached, according to one or more embodiments of the disclosed subject matter.

FIG. 10 shows a torque tube subcomponent, according to one or more embodiments of the disclosed subject matter.

FIG. 11 shows is a perspective view of an azimuth drive, according to one or more embodiments of the disclosed subject matter.

FIG. 12A is a perspective view of an elevation drive, according to one or more embodiments of the disclosed subject matter.

FIG. 12B is a perspective view of the elevation drive illustrated in FIG. 12A with a main housing thereof removed, according to one or more embodiments of the disclosed subject matter.

FIG. 13 shows a mirror assembly, which includes two mirrors, according to one or more embodiments of the disclosed subject matter.

FIG. 14 shows a power control module (PCM) assembly attached to a mirror, according to one or more embodiments of the disclosed subject matter.

FIG. 15 is a perspective view of a power control module (PCM) assembly, according to one or more embodiments of the disclosed subject matter.

FIG. 16 shows an exploded view of a power control module (PCM) of the PCM assembly illustrated in FIG. 15, according to one or more embodiments of the disclosed subject matter.

FIG. 17 shows a heliostat with a torque tube assembly, according to one or more embodiments of the disclosed subject matter.

FIG. 18 shows a heliostat with the torque tube assembly installed on a pylon, according to one or more embodiments of the disclosed subject matter.

FIG. 19 shows a modular heliostat assembly apparatus with two cells, according to one or more embodiments of the disclosed subject matter.

FIG. 20 shows a modular heliostat assembly apparatus with four cells and a power unit, according to one or more embodiments of the disclosed subject matter.

### DETAILED DESCRIPTION

Insolation can be used by a solar thermal system to generate solar steam and/or for heating a fluid, such as a molten salt or a gas, which may subsequently be used in the production of electricity. A solar thermal system can include a solar tower, which has a target that receives reflected insolation from a solar field, which at least partially surrounds the solar tower. The target can be a solar energy receiver system, which can include, for example, an insolation receiving surface of one or more solar receivers configured to transmit heat energy of the insolation to a working fluid or heat transfer fluid flowing therethrough. The target may include one or more separate solar receivers (e.g., an evaporating solar receiver and a superheating solar receiver) arranged at the same or different heights or positions. Alternatively or additionally, the target or receiver can include, but is not limited to, a photovoltaic assembly, a steam-generating assembly (or another assembly for heating a solid or fluid), a biological growth assembly for growing biological matter (e.g., for producing a biofuel), or any other target configured to convert focused insolation into useful energy and/or work. The solar field can include a plurality of heliostats, each of which is configured to direct insolation at the target on the solar tower. Heliostats within the solar field can adjust their orientation to track the sun as it moves across the sky, thereby continuing to reflect insolation onto one or more aiming points associated with the target. The solar field can include, for example, over 50,000 heliostats deployed in over an area of approximately 4 km².

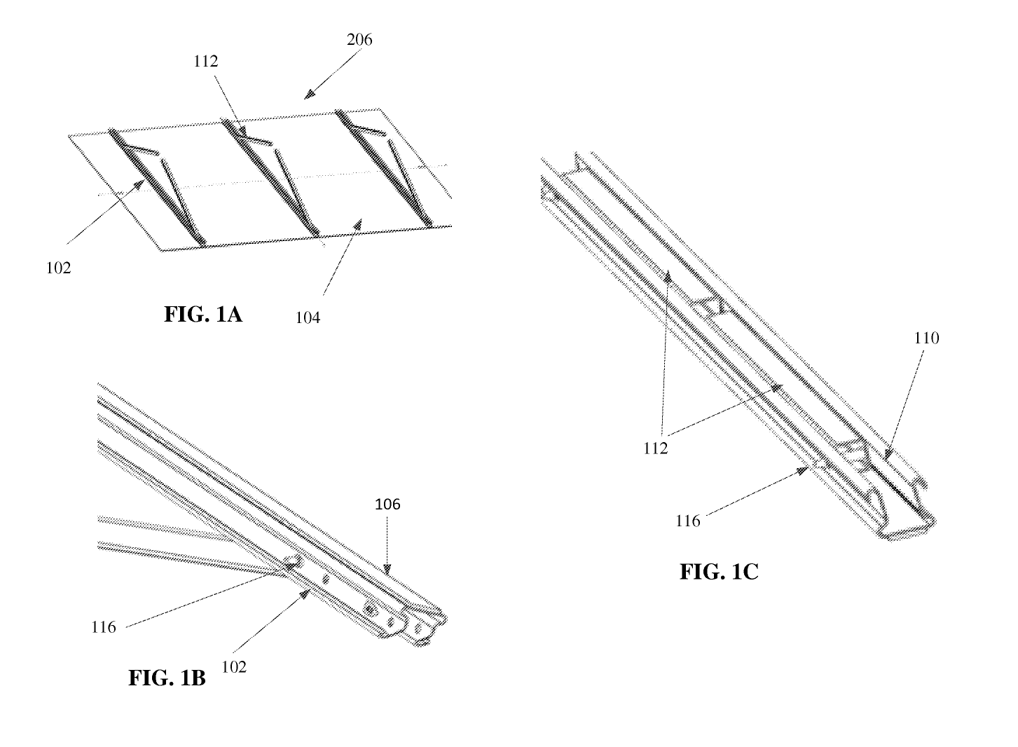

According to some embodiments described here, as illustrated in FIG. 1A, support arms 102 are directly attached onto the non-reflective face of a mirror 104. For illustrative purposes, FIG. 1A illustrates a mirror 104 with three support arms 102 attached to its non-reflecting face. Any amount of support arms may be used, for example, there may be one or two support arms especially for a smaller mirror, or even four or more. The mirror 104, support arms 102, and pair of diagonals 112, form mirror assembly, 206. By folding each of the pair of diagonals, each diagonal may be substantially flush with and parallel to the support arm.

The support arms 102 may be provided to support the mirrors 104 along the mirror width. In some embodiments, several (e.g., three) support arms 102 are provided per mirror 104, parallel to each other and equally spaced from one another. Each support arm 102 may be made from any suitable material, for example steel, aluminum, or a composite material, such as a plastic, and may be manufactured using any suitable process, such as rolling, brake-pressing, or extrusion. The length of support arm 102 may be equal to that of the mirror, or less than the length thereof.

According to some embodiments described here, FIG. 1B illustrates support arms 102 which may be adhered to the non-reflective face of the mirrors (not shown in FIG. 1B) with an adhesive such as an adhesive tape 106. A non-limiting example of an adhesive tape is Very High Bonding VHB™ Acrylic foam adhesive tape manufactured by 3M™. This adhesive tape is recommended for use especially under extreme outdoor conditions. Solar fields are often situated in deserts where there is an abundance of solar radiation; therefore adherence needs to be very strong and capable of withstanding extreme temperatures, storms, and high powered winds. Other examples of adhesive tapes that may be used are: Orafols® Oramount 1800 series, Tesa®'s double sided mounting tapes, Mactac®'s Solarhold™, Cell Holding Tape and Solarfast™, UV Cure Adhesive System products for Soar Cell Assembly and Solarconnect™, Saint-Gobain's Normount® V8800, and SolarBond™ A0500. Other adhesives apart from pressure sensitive adhesives can be used, such as liquid single or double components adhesives.

Among additional advantages of support arms 102 being adhered directly to the non-reflective face of the mirrors 104 are that the support arms 102 serve to stiffen the mirrors 104 and that they spread the stress of any ambient wind over the entire length of support arms 102 since they are preferably attached along the whole length of the arms 102 instead of at a number of attachment points, as in the prior art.

Such an adhesive tape is often used in conjunction with mechanical support. According to some embodiments described here, mechanical support is not necessary if the areas to be stuck together are cleaned rigorously by a machine prior to use.

When pressure sensitive adhesives are used to adhere the support arms to the mirrors as mentioned above, some of the curing of the adhesive occurs immediately, which is also known as a snap cure which may amount to about 20% of the final adhesion force. The remainder of the adhesive curing period can coincide with the storage and transportation time to the solar field heliostat assembly site. After adhering the support arms to the non-reflective face of the mirrors, the mirrors may be placed in a substantially vertical position such that the adhesive tape bears the weight of the support arm and the diagonals attached thereto and/or withstand the shear stress of the support arms on the mirrors. The mirror assemblies may then be stacked for storage and transportation in a vertical position to a place in proximity to the solar field.

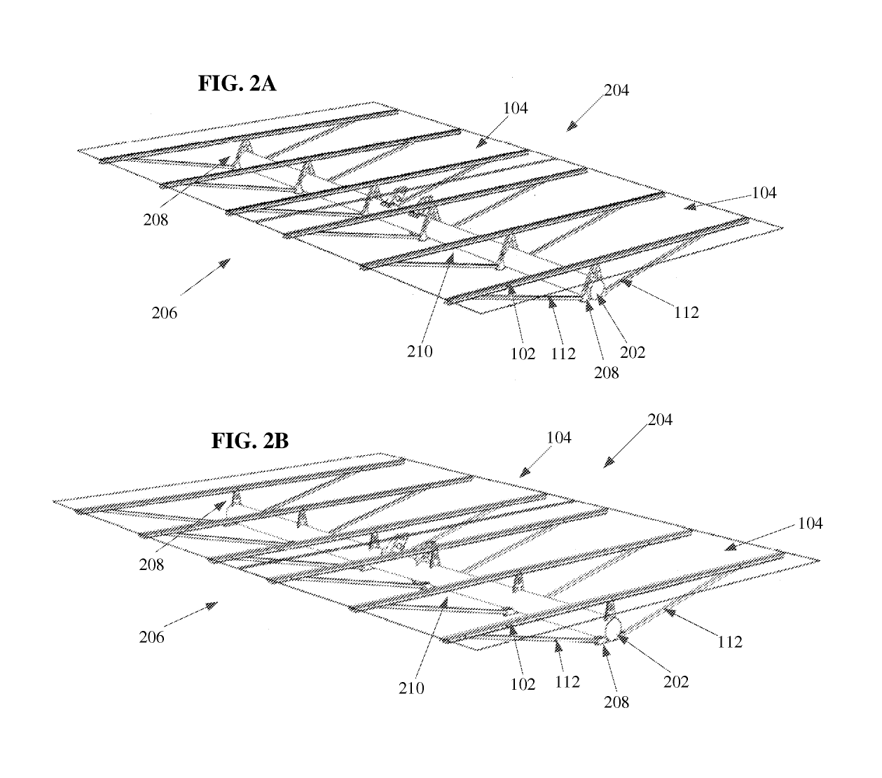

As illustrated in FIGS. 2A and 2B, a reflection unit 204 may comprise the mirror assembly, which is generally indicated at 206, the torque tube 202, and connectors 208. (It will be appreciated that in FIGS. 2A and 2B the mirrors 104 are illustrated as transparent in order to facilitate illustration of the elements therebelow.) Each support arm 102, together with two of the diagonals 112 attached thereto, and connectors 208 constitutes a truss 210. The connectors 208 bear against the torque tube 202, thereby reinforcing the truss 210, and simultaneously serve to carry the torque tube, thereby facilitating transfer of motion thereof to the mirror 104. The connectors 208 may be formed from one, two or more components. For example, (see FIG. 2B) some embodiments include a component between the torque tube and the support arm termed A-plate hereinbelow and a component between the torque tube and the diagonals referred to as a U-bar hereinbelow.

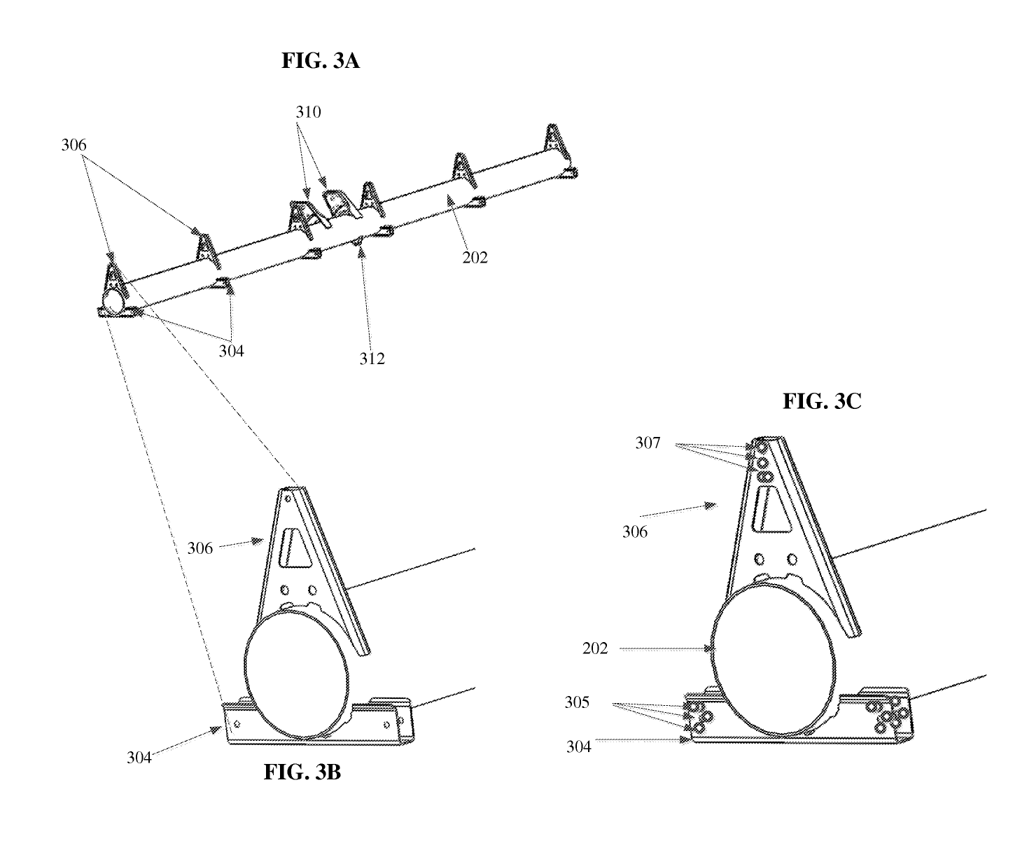

FIG. 3A illustrates a torque tube 202 configured for holding two mirrors having for example, three U-bars 304 and three A-plates 306 on each half of the torque tube 202 configured for holding three support arms for each mirror. As stated above, the number of support arms may be two or four or any other number. In some embodiments, torque tube 202 may also comprise a pair of azimuth shaft holders 310 and an elevation tip drive holder 312.

The torque tube 202 may be a hollow tube with openings at both ends. It may be made of any suitable material, and has sufficient mechanical strength to transfer mechanical energy in the form of rotational motion to the mirror assembly 206 without undergoing deformation to the extent which it would adversely affect its operation.

As shown in FIGS. 3A-3C, the location of the connectors 208 along the torque tube may define the curvature of the mirror (i.e. concavity of the mirror in at least one axis), which may define the focal length of the mirrors. In some embodiments, connectors 208 may be U-bar 304 and A-plate 306. U-bar 304 may be designed and configured for accepting and being attached to the end of diagonals which has been unfolded from the support arms of the heliostats. The A-plate 306 may be attached to the support arm itself preferably wedged into the groove thereof. An enlarged sectional view of the U-bar 304 and A-plate 306 is illustrated in FIG. 3B.

According to some embodiments, a preferred shape for a heliostat mirror may be a solid parabola or a concave shape sufficiently concave to produce a beam that focuses on a point such as a receiver in a solar field. The location (i.e. placing) of the connector 208 may be calculated by using, for example, the disturbances method. In the disturbances method, it is recognized that the torque tube 202 is composed of many different components, each having its own tolerance and therefore each part or element or property thereof may have a different impact on the shape of the mirror for example. As mentioned above, examples of parts having an impact on the mirror shape are the A-plates 306 and U-bars 304, which are attached to the diagonals and the support arms. Therefore the exact placement of the holes in at least one of, the A-plates, the U-bars may have an impact on the shape of the mirror.

By using, for example, a finite element model (FEM) the effect of parameters of interest such as the positions of the holes on the curvature of the mirror are simulated and the model is then run. FEMs utilize linear algebra and a dimensional linear problem can then be computed.

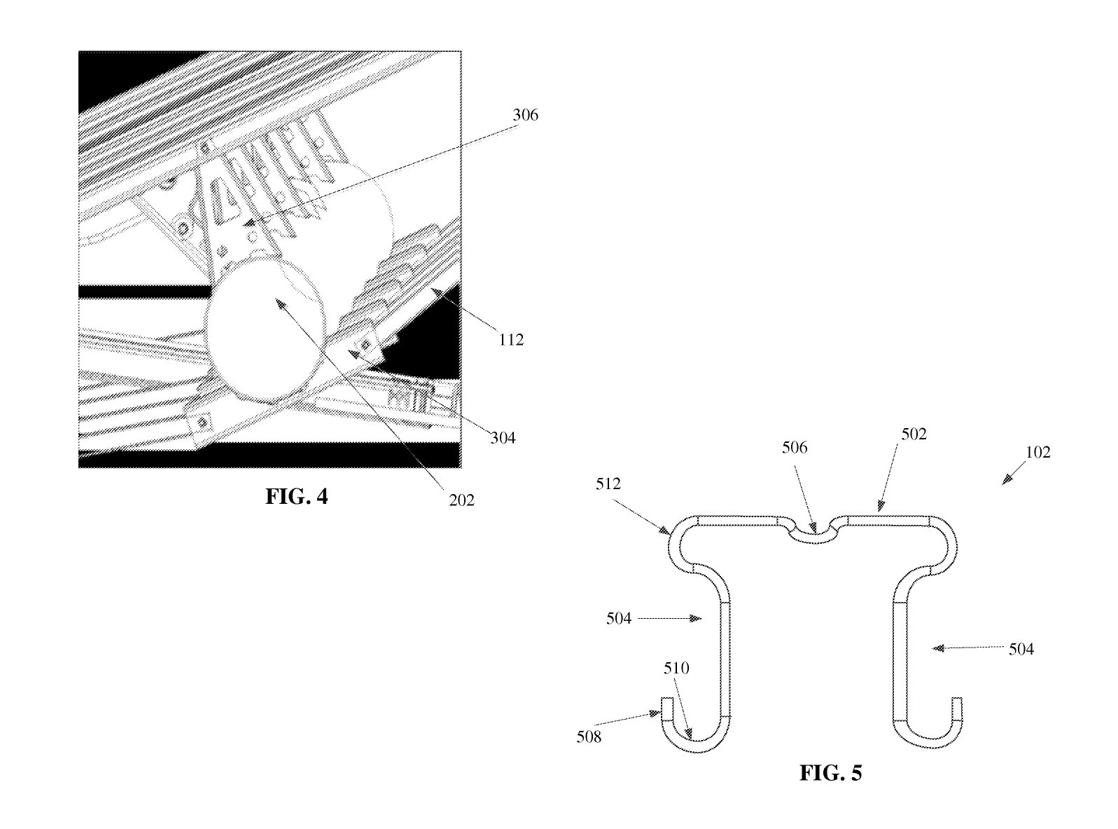

As a way to illustrate this, referring to FIG. 4, if the attachment point of diagonals 112 to U-bars 304 were to be different or if the positioning of A-plate 306 were to be different, the mirrors may be more or less curved, which thereby defines the focal length of the mirror. This may be demonstrated in FIG. 3C. Attachment holes 307 for the attachment of A-plate 306 to the support arm and attachment holes 305 for the attachment of U-Bars 304 to the diagonals are shown. In order to effect a different mirror shape, the attachment holes may be only very slightly up, down, to the right or to the left for each new mirror shape as can be seen for example with some of the overlapping holes in FIG. 3C. These minor hole position differences would make it impractical to have different holes positioned in each component because the distance between the position of one hole and the position of another hole may be less than the diameter of the first hole. Each set of holes (i.e. in the U-bars and/or the A-plates, and the holes in the diagonals and/or the support arms) may define a focal length of a heliostat. Heliostats found within a predefined radius may be designed to have a common focal point, therefore there may only be a need to manufacture a relatively small number of A-plates and U-bars with different hole positions. While some hole/aperture positions may have an effect on the shape of the mirror in a longitudinal axis or y axis, others may have an effect on the horizontal or x-axis.

In certain embodiments, as can be seen for example in FIG. 5, each support arm 102 may be formed as an elongate member having a generally omega-shaped profile, with a top wall 502 and two sidewalls 504 projecting substantially perpendicularly therefrom in a downward direction. The top wall 502 may be generally flat, so as to be suited for adhering the mirror thereto, and is formed with a top channel 506 (seen as an inwardly-directed dimple in FIG. 5) extending the length of the support arm 102. The bottom-most portion of each of the sidewalls 504 may terminate with an upturned end 508, each defining a side channel 510. The top of each sidewall 504 may be formed as an outwardly-projecting bulge 512 in the area adjacent to its connection to the top wall 502. The above-described cross-sectional shape of the support arm 102 increases the bending moment of inertia thereof, for example when compared to a channel- or L-shaped profile of the same length and/or weight.

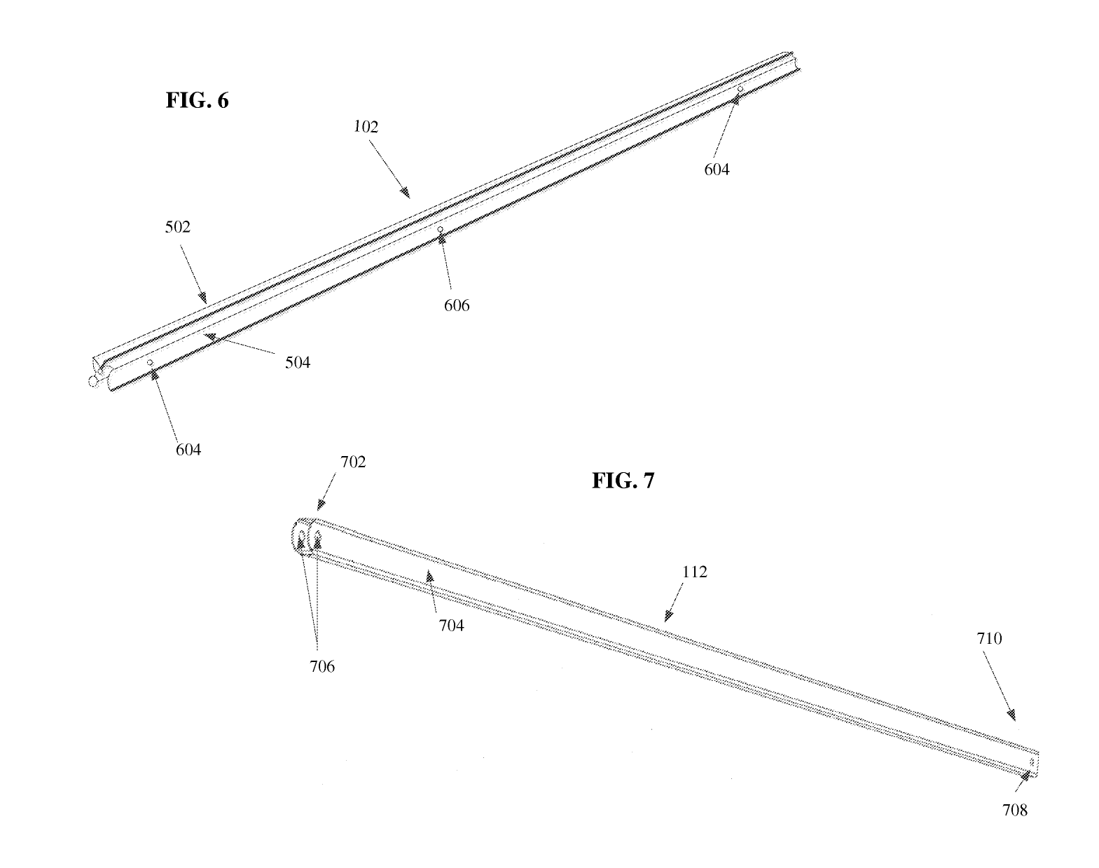

As illustrated in FIG. 6, the sidewalls 504 may comprise diagonal-mounting apertures 604, which may be spaced equidistantly from central support-mounting apertures 606. The diagonal-mounting apertures 604 and central support-mounting apertures 606 may be each associated with corresponding apertures formed opposite thereto in the other sidewall 504. It will be appreciated that the diagonal-mounting apertures 604 may be formed non-symmetrically along the length of the support arm 102, with one of the sets of diagonal-mounting apertures being formed closer to one end of the support arm than the other set is formed to the other end of the support arm.

When the reflection unit 204 is fully assembled, the support arm 102 may have a curved shape, for example a parabolic or near-parabolic shape, which also may give the attached mirror the same shape, hence creating a focal point. This may be accomplished either by manufacturing the support arm 102 with the required shape, or by providing the support arm as a straight element, and bending it during assembly of the reflection unit 204. In the latter case, the desired shape can be achieved, e.g., by adjusting the length of the diagonals during assembly of the truss, or by precisely forming the diagonal mounting apertures 604, with precise fastening elements provided to fasten the diagonals to the support arms.

As illustrated in FIG. 7 and as mentioned above, each diagonal 112 may be formed as an elongate member having a rectangular hollow structural section (HHS) profile. The diagonals 112 may be formed by extrusion, or by any other suitable method. A proximal end 702 of each diagonal may be rounded, as illustrated in FIG. 7, or it may be flat. Each of the two parallel disposed side panels 704 of the diagonal 112 may be formed with a support arm-mounting aperture 706 near the proximal end 702, and a connector attachment aperture 708 near a distal end 710 of the diagonal. Each of the apertures 706, 708 is formed opposite the corresponding aperture formed in the other side panel 704.

The ends of the support arm 102 may be formed so as to define a plane which is perpendicular to the direction in which the support arm extends (not shown). Alternatively, as illustrated in FIG. 7, the ends of the diagonal 112 may be formed so as to define a plane which forms an acute angle with respect to the direction in which the support arm extends.

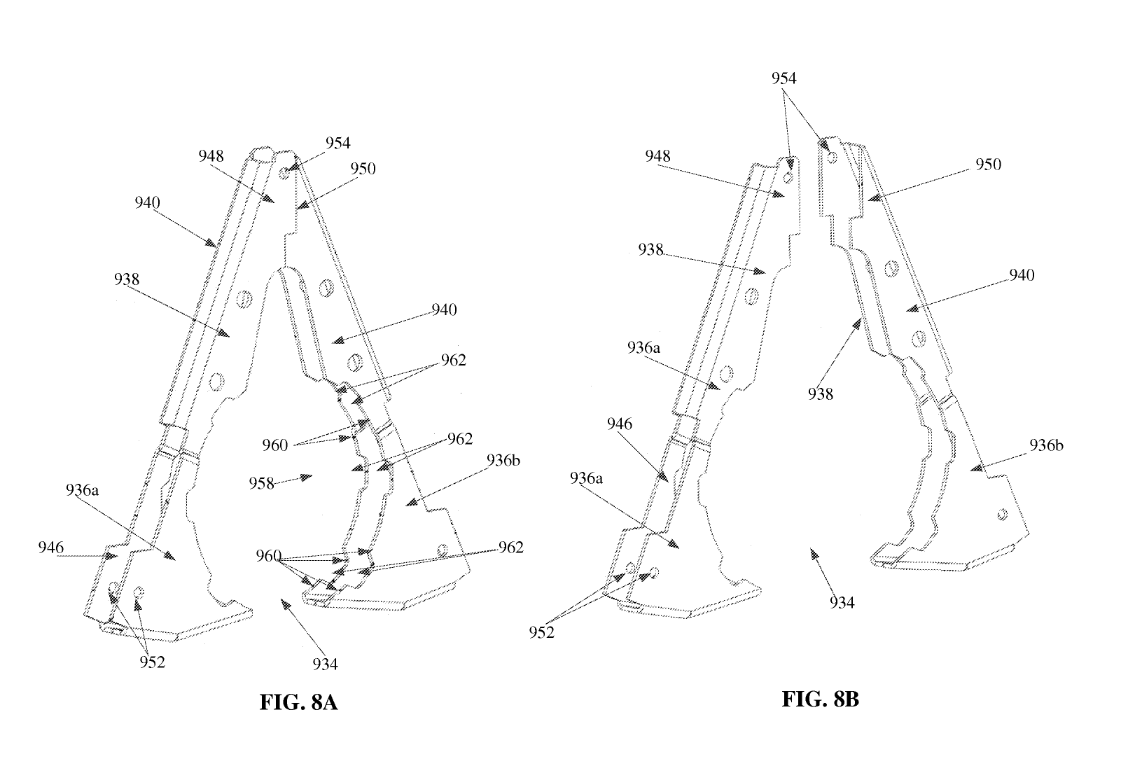

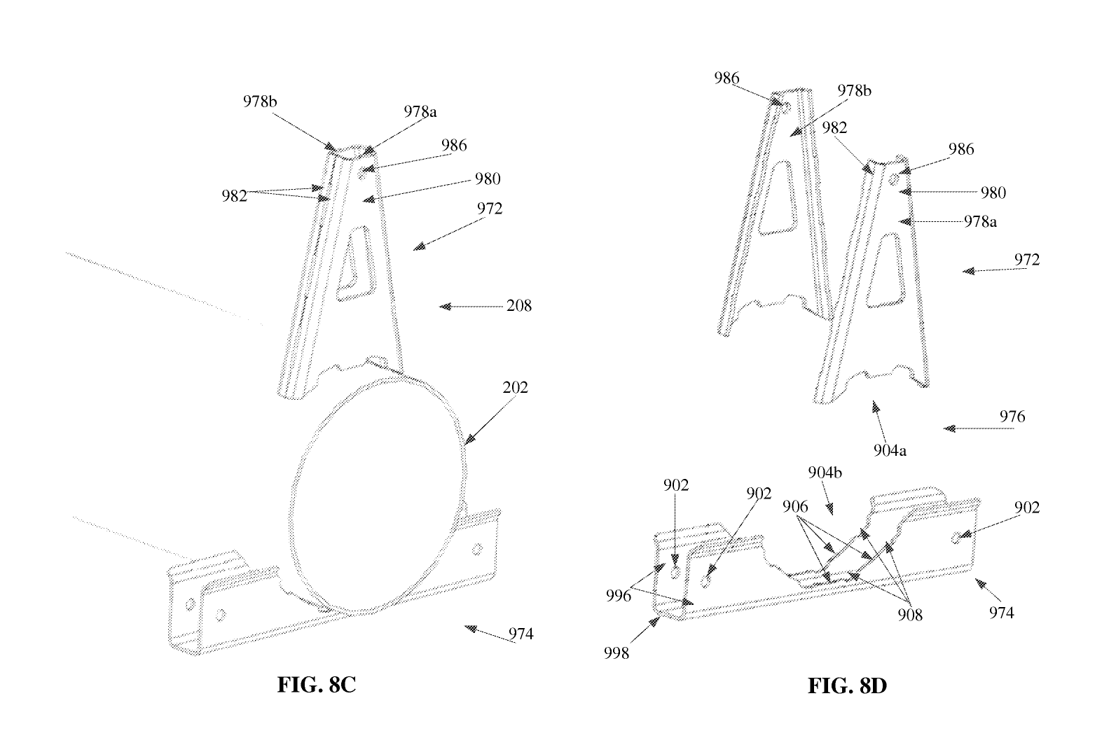

As mentioned above, the connectors 208 a may be provided in order to reinforce the truss 210, and to carry the torque tube 202 (i.e., it facilitates the carrying of the truss by the torque tube). According to one example, as illustrated in FIGS. 8A and 8B, the connectors 208 may have a generally triangular shape, and comprises a generally round jaw 934, which may be configured for gripping the torque tube 202. It comprises identical first and second sections 936a, 936b (hereafter, the first and second sections, when referred to collectively, will be indicated by reference numeral 936), each being disposed such that it is displaced through a 180 degree rotation relative to the other. Each section 936 comprises a front face 938, a rear face 940, and a gap 946 spanning between and separating the front and rear faces.

The front face 938 of each section 936 can be formed with an overhang 948 at an upper end thereof, with the rear face 940 being formed with a corresponding notch 950. The notch 950 may be formed so as to receive therein the overhang 948. Each section may be further formed with a front diagonal-receiving aperture 952 near a lower end thereof, and a support arm-receiving aperture 954, which is formed within the overhang 948.

The jaw 934 is defined by sockets, which are generally indicated by 958, formed in each of the front and rear faces 938 of each section 936. Each socket 958 comprises several torque tube-contacting surfaces 960, separated by several notches 962. This structure provides the connector 208 with flexibility, in particular in the area of the jaw 934, facilitating application of pressure by the jaw on the torque tube 202 when received therein. This pressure may be applied by providing an inwardly directed force on the connectors 208, for example by adjusting the positions of the diagonals 112.

When the connector 208 is assembled, the sections 936 thereof are arranged such that the front face 938 of each section lies in coplanar registration with the rear face 940 of the other section, with each overhang 948 being received within the corresponding notch 950 of the other section. When the sections 936 are so arranged, the support arm-receiving apertures 954 are disposed opposite one another.

The truss 210 may be assembled as follows:
first and second sections 936a, 936b are provided, and arranged such that the first section is displaced through a 180 degree rotation relative to the second section, with the front face 938 of each section lying in coplanar registration with the rear face 940 of the other, thus constituting a connector 208;
the sections 936 are arranged such that a torque tube 202 is received within and gripped by the jaw 934 of the connector;
the connector 208 may be attached to the support arm 102 by securing a fastening member through the central support-mounting apertures 606 of the support arm and the support arm-receiving apertures 954 formed within the overhangs 948 of sections 936 of the connector;
two diagonals 112 are provided, with the proximal end 702 of each diagonal being attached to the support arm 102 by securing a fastening member, which may be for example a high-strength anti-fatigue rivet, through the support arm-mounting aperture 706 of each diagonal and one of the diagonal-mounting apertures 604 of the support arm; and
the distal end 710 of each diagonal 112 may be received within the gap 946 and disposed between the sections 936 of a connector 208; it is attached thereto by securing a fastening member through a connector attachment aperture 708 of the diagonal and the diagonal-receiving apertures 952 of the connector.

It will be appreciate that the above describes one example of how the truss 210 may be assembled, and any other suitable methods may be employed as well.

According to another example, as illustrated in FIGS. 8C and 8D, the connector 208 comprises an upper jaw portion 972 having a generally triangular shape, and a lower jaw portion 974. According to this example, the upper and lower jaw portions 972, 974 of the connector 208 define a generally rounded jaw 976 having open sides, and which is configured for gripping torque tube 202. In embodiments, upper jaw 972 may be defined as an A-plate and lower jaw 974 may be defined as a U-bar.

Upper jaw portion 972 comprises first and second sections 978a, 978b (hereafter, the first and second sections, when referred to collectively, will be indicated by reference numeral 978), each being disposed so as to mirror the other. Each section 978 of the upper jaw portion 972 comprises a front face 980 and sidewalls 982. The front face 980 is formed with a support arm-receiving aperture 986 formed at a top end thereof (which is also the top end of the connector 208).

The lower jaw portion 974 is formed with a substantially U-shaped profile having sidewalls 996 and a flat bottom 998. Each of the sidewalls 996 is formed with two diagonal receiving apertures 902 formed as opposite ends thereof at the bottom end of the connector 208.

The jaw 976 may be defined by upper and lower sockets, formed, respectively, in the upper and lower jaw portions 972, 974, and which are generally indicated by 904a and 904b, respectively (hereafter, the upper and lower sockets, when referred to collectively, will be referred to as “sockets”, and indicated by reference numeral 904). Each of the sockets 904 may comprise several torque tube-contacting surfaces 906, separated by several notches 908. This structure provides the connector 208 with flexibility, in particular in the area of the jaw 976, facilitating application of pressure by the jaw on the torque tube 202 when received therein. This pressure may be applied by providing an upwardly (i.e., toward the torque tube 202) directed force on the lower jaw portion 974, for example by adjusting the positions of the diagonals 112. In some embodiments, connectors 208 may be attached to the torque tube by any means such as soldering prior to the attachment of the torque tube to the support arms and diagonals.

Adjacent trusses 210 may be arranged at different positions along the torque tube 202 to form a truss assembly, such that support arms 102 lie along a curved path, with the outermost support arms being spaced farthest from the torque tube, and the innermost support arms being spaced closest thereto, i.e., the curve is open toward the mirror 104. The shape of the curve may be parabolic or near parabolic. The curved arrangement of the support arms 102 causes the mirror 104 to take on a curved shape in a direction perpendicular to the length of the support arms.

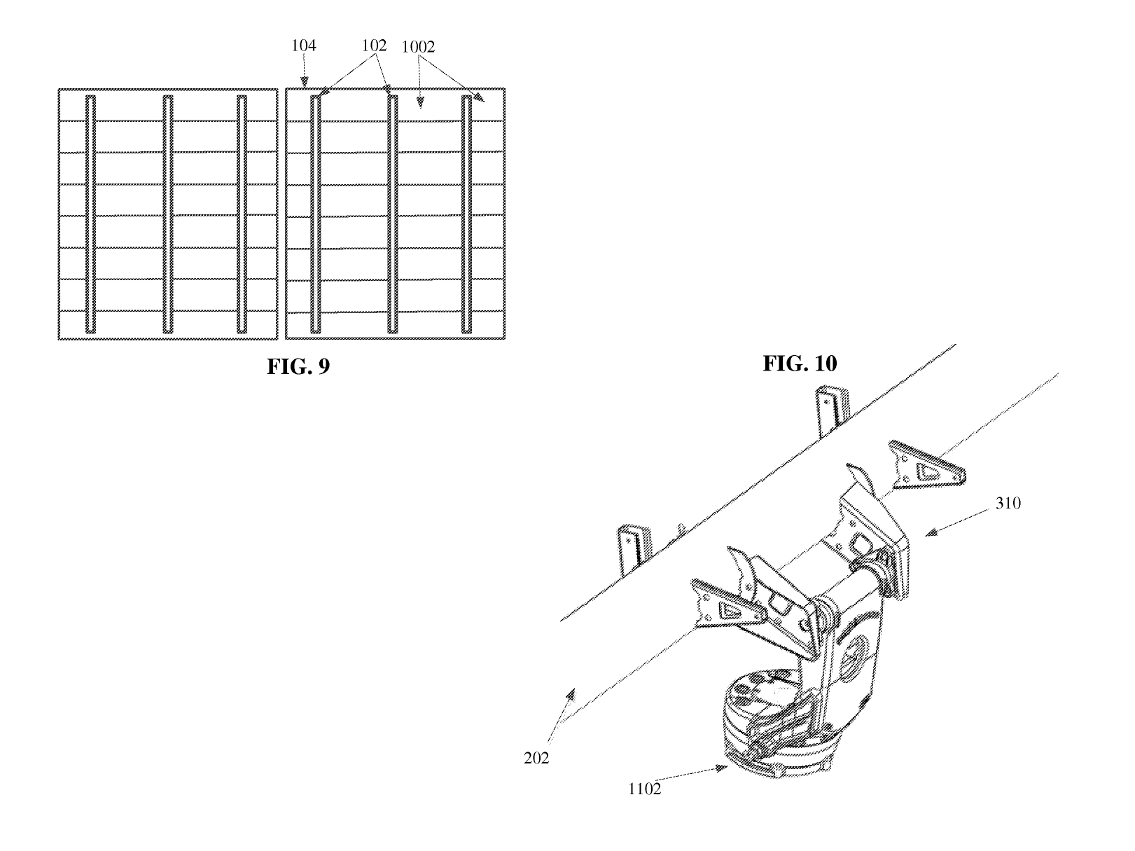

The mirrors 104 may be planar elements with a highly reflective face and a non-reflective face. Each mirror 104 may be a single piece, as illustrated for example in FIGS. 2A and 2B. According to a modification, as illustrated in FIG. 9 (in which only the mirrors 104 and support arms 102 are illustrated), each mirror may be constituted by several mirror strip elements 1002, which are arranged perpendicularly and attached to the support arms.

The mirrors 104 may be made of a low-iron glass or any other suitable material. They may be at least slightly flexible, for example to facilitate bending into a parabolic shape, as described above. The mirror reflectivity may be over 90%, for example 92.5%. The non-reflective face of the mirrors thereof may be provided with a coating which is designed to protect the mirrors from a harsh environment, for example a desert environment.

Diagonals connect the support arms which are attached to the non-reflective face of the mirrors to, for example, a torque tube or connectors. The precise positioning and placement of the diagonals at both attachment ends to both the support arms (the proximal end) and the torque tube (at the distal end) may be very important for determining the focal length of the attached mirrors. To this end the precise positioning of the points of attachment and drilling of the holes may also be performed off-site. According to some embodiments, as illustrated in FIG. 1C the support arm 102 may be U-shaped ( [symbol] ) which may provide more support to the mirror as there are three sides for support instead of two. An additional advantage of having a U-shaped support arm 102 is that diagonals 112 may be attached at one end to the support arm, and may be collapsed or folded into the groove of the support arm. In a further embodiment, diagonals 112 are U-shaped and cover at least a portion of the support arm when folded down. With the support arm and/or the diagonals having a U-shaped design, the mirror assembly would be less voluminous for more efficient shipping and storage at a heliostat assembly site near the solar field. A plurality of mirror assemblies may be stacked in a substantially vertical position, whose stack thickness is equal to the number of stacked mirrors multiplied by the sum of the thickness of a mirror and the greater of the thicknesses of the attached support arm and of the attached pair of diagonals.

According to some embodiments, a heliostat assembly may include at least two support arms attached to the non-reflective face of the mirror and having a height normal to the plane of the non-reflective face of the mirror, and a pair of diagonals, each having a height and attached to each of the at least two support arms. A proximal end of each diagonal may be attached to one end of the support arms and each diagonal is configured to be folded so as to be substantially parallel to the support arm. The combined height of the support arm and the folded pair of diagonals is substantially the same as that of the one with the greater height. In some embodiments the diagonals are configured to collapse into the groove of the support arm and the support arm height is greater than the diagonal height. In a further embodiment, the diagonals are configured to cover the support arm and the diagonal height is greater than the support arm height. A distal end of the diagonal may be configured for attaching to an elongated central support element or a connecting element attached thereto.

As illustrated in FIG. 1C, a pin 116, for example a grooved pin and circlips, may be used for the attachment of the proximal end of the diagonal to the support arm. The distal end of the diagonal may be unfolded so as to attach at least one mirror to a crosswise element such as a torque tube. Each support arm 102 may accommodate two diagonals 112 whose proximal end may pivot with respect to the ends of the attached support arms and the distal ends of the diagonals may open up on assembly in order to accommodate a crosswise element such as a torque tube. The torque tube may be loaded with one or more drives and control units, thereby forming a torque tube subcomponent.

As mentioned hereinabove, the mirrors attached to support arms and folded diagonals may be stacked vertically and transported to an assembly site preferably near a solar field where the heliostats are to be installed.

Prior to abovementioned attachment of the torque tube to the diagonals which are connected to support arms and mirrors, torque tube 202 may be loaded with an azimuth drive 1102, as illustrated in FIG. 10. Azimuth drive 1102 is attached to the two azimuth drive shaft holders 310 which are attached to torque tube 202.

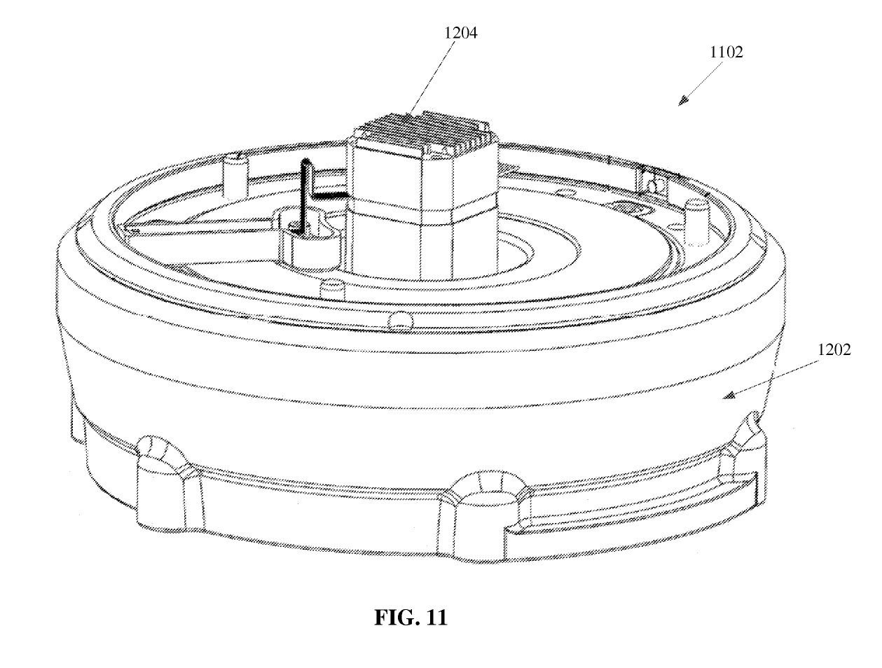

FIG. 11 is an exemplary illustration of an azimuth drive 1102. The azimuth drive comprises a casing 1202. The casing 1202 is bowl-shaped, i.e., it has a concave shape open toward an upper end thereof. The interior of the casing 1202 may be formed with several shelves, for supporting the various elements of the azimuth drive 1102.

Azimuth drive 1102 may include a motor assembly 1204 in order to supply the mechanical energy required for rotation of the azimuth drive 1102. The motor assembly 1204 may comprise a controller and a motor. The motor may be any suitable device for converting electrical energy into mechanical energy, for example rotational energy. It may be provided as a stepper motor, which is configured for having its operation directed by the controller. It comprises a stator assembly which houses a stepper rotor, and an output shaft.

An advantage of using a stepper motor as the motor of the motor assembly 1204 is that it can be used to rotate the heliostat in small increments. Another advantage is that its torque increases with a decreased speed thereof. Thus, as its speed is very low during use, it can provide a relatively high degree of force to the heliostat, for example to counteract external forces acting it, e.g., from wind, etc.

Although the present description discloses a motor which provides rotational energy, it will be appreciated that the motor may provide another type of mechanical energy (for example it may comprise a linear actuator); one having ordinary skill in the art will recognize that appropriate transmission and/or gearing elements should be provided to translate the motion provided by the motor into the necessary rotational motion necessary to rotate the heliostat.

Azimuth drive 1102 may also include a planetary gear train to control transmission of the mechanical (in this case, rotational) energy provided by the motor to the heliostat. A harmonic drive may also be a part of azimuth drive 1102. The harmonic drive may be configured to transmit rotational motion from the planetary gear train for providing the rotation necessary to control the azimuth angle of the heliostat. The harmonic drive may comprise a wave generator, a flexible spline, and a circular spline.

In operation, the controller makes a determination, for example based on an outside instruction, to rotate the heliostat a predetermined amount. The controller may then instruct the motor to rotate the motor's output shaft an amount which will, taking into account the gear ratios of the planetary gear train and the harmonic drive, and rotate the heliostat the predetermined amount. An azimuth drive as described in Chinese Utility Model Patent CN201220379027.2 is hereby incorporated by reference.

According to some embodiments, it may be advantageous to install an elevation drive only after all of the other components have been installed as it may become damaged while the other parts are being installed as an elevation drive may be fragile. According to some embodiments, an elevation drive may be installed prior to attachment of the mirror assembly to the torque tube subcomponent.

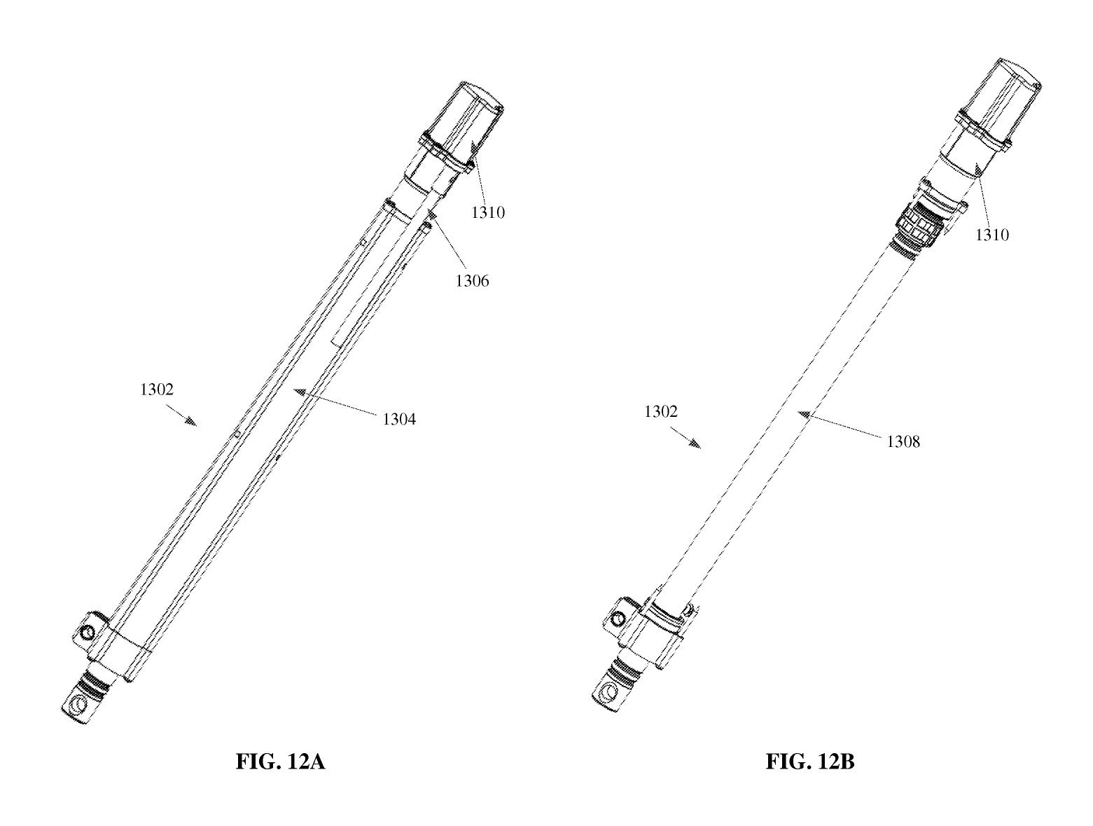

As illustrated in FIGS. 12A and 12B, the elevation drive 1302 may comprise a control unit 1310, a main housing 1304, an electric piston 1308, and a cable 1306. The control unit 13010 may be configured to direct operation of the elevation drive 1302 and to utilize electrical energy to provide mechanical energy to the electric piston 1308. The electric piston 1308 may be configured to utilize the mechanical energy to extend and/or to retract relative to the main housing 1304, thereby bringing about a relative rotation of the torque tube 202 about the pylon, and pivoting the reflective surface of the heliostat to adjust its elevation angle, as will be explained below. The cable 1306 may be configured for facilitating communication with the control unit 1310, as well as supplying power thereto.

The control unit 1310 may comprise a motor unit and a transmission unit. The motor unit is configured to provide the mechanical energy required by the electric piston 1308. It may therefore comprise a motor and a controller.

The motor may be any suitable device for converting electrical energy into mechanical energy, for example rotational energy. It may comprise a stepper motor, which is controlled by the controller. It may further comprise a mounting plate, a stator assembly which has a stepper rotor and an output shaft.

An advantage of using a stepper motor is that it can be used to rotate the torque tube in small increments. Another advantage is that its torque increases with a decreased speed thereof. Thus, as its speed is very low during use, it can provide a relatively high degree of force, for example to counteract external forces acting on the reflective surface, e.g., from wind, etc.

Although the present description discloses a motor which provides rotational energy, in other embodiments a motor may provide another type of mechanical energy (for example, it may comprise a linear actuator); one having ordinary skill in the art will recognize that appropriate transmission and/or gearing elements should be provided to translate the motion provided by the motor into the motion necessary to rotate the torque tube.

The transmission unit is provided to transmit the mechanical energy from the motor to the electric piston 1308. In doing so, it may reduce the speed of mechanical energy provided, and increase the torque thereof (or vice-versa). The transmission unit housing may be rigidly attached to the motor at a top end thereof, and to the main housing 1304 at a bottom end thereof. It may further comprise a compound planetary gear system.

The electric piston 1308 may comprise a piston rod formed as a hollow tube with a threaded shaft (which may be a ball screw) received therewithin, such that two are adapted to move longitudinally in relation to one another. The main housing 1304 of the elevation drive 1302 constitutes a piston housing of the electric piston 1308. In addition, the electric piston comprises a shaft support, and a nut assembly. The shaft support may be provided in order to provide stability to the threaded shaft.

In use, the controller sends a signal to the motor to rotate its output shaft. As described above, this causes a rotation of the threaded shaft. Owing to the threading of the threaded shaft within the nut assembly, the rotation of the threaded shaft causes the nut assembly to slide longitudinally within the main housing 1304, resulting in an extension or retraction of the piston rod, and thus of the end cap attached thereto, with respect to the main housing 1304. This movement of the end cap results in a change in distance between a through-going bore of the end cap and a through-going aperture of a projection attached to the bottom end of the main housing. The change in distance results in a pivoting of the torque tube 202, leading to a change in the elevation angle of the reflective surface. An elevation drive as described in Chinese Utility Model Patent CN201220366141.1 is hereby incorporated by reference.

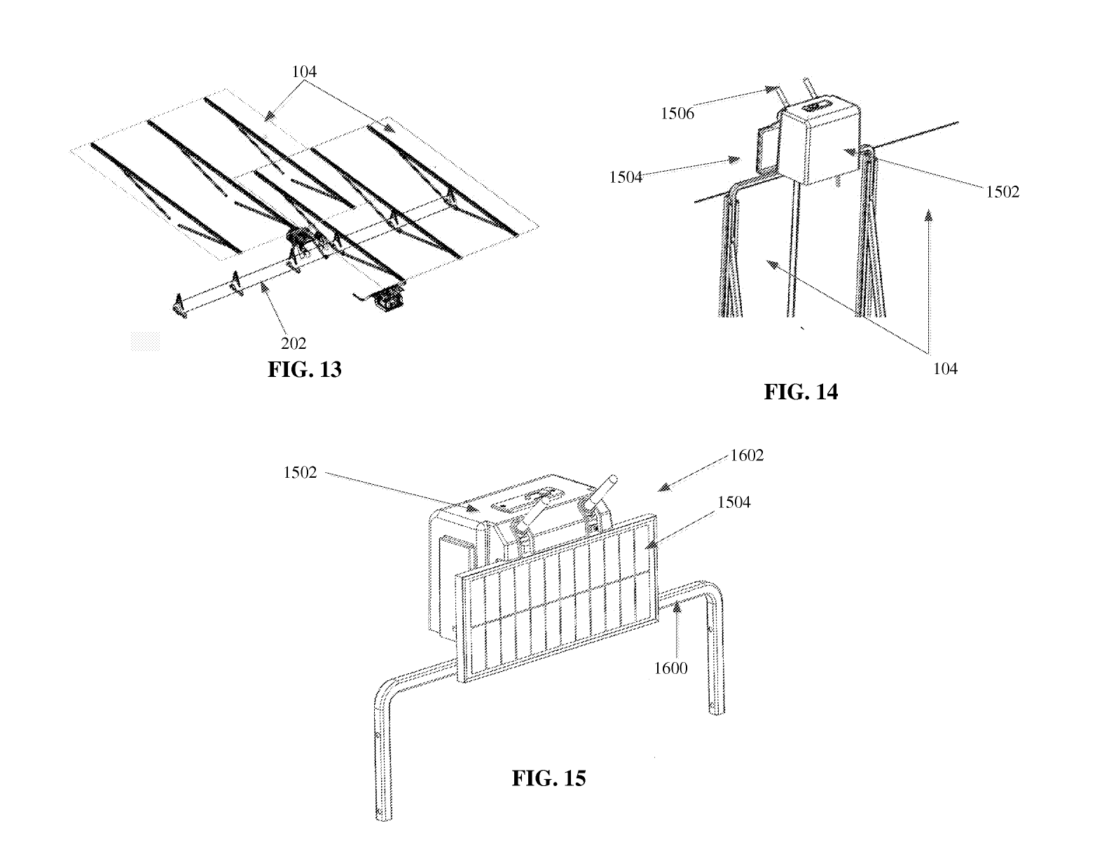

According to some embodiments described here, the mirror assemblies may be transported to a heliostat assembly site where in an assembly cell the mirror assemblies are connected to a torque tube or a torque tube subcomponent which includes a torque tube with an azimuth drive and elevation drive attached thereto. As illustrated in FIG. 13, a semi-exploded view torque tube 202 may accommodate at least one and preferably two mirrors 104. In alternative embodiments the torque tube 202 may accommodate three or four or more mirrors.

As can be seen in FIG. 4, U-bars 304 may be configured such that when a diagonal 112 is opened after torque tube 202 is in a predesignated position for attachment to the diagonals 112, the diagonals open only as far as U-bar 304 which stops the diagonal 112 from opening any further. When the distal end of the diagonal is in the U-bar, the diagonal and U-bar may be connected by any connecting means such as but not limited to pins such as grooved pins with circlips, rivets, struts, nuts and bolts and the like.

When the mirror assembly has been connected to the torque tube subcomponent, a Power Control Module (PCM) may be connected. A Power Control Module assembly as described in Chinese Utility Model Patent CN201220734120.0 is hereby incorporated by reference.

Due to high cost of the cabling, wireless self-powering heliostats are preferred wherein a heliostat may move with energy derived from a linked solar energy device and the self-powering heliostat is in wireless communication with the other elements of the solar field. According to some embodiments, a control module of an autonomous heliostat may derive its energy from the sun via a photovoltaic panel (PV) which could be utilized for powering the heliostat. Energy from the PV panel may be stored using any type of storage solution knows to those skilled in the art, such as batteries (e.g. lead acid batteries, NI-CAD and NI-Hydride), capacitors, hydrogen fuel cells, etc. The PCM may also be in wireless communications with other heliostats, a nearby Access Point or a central control. The most practical means to enable wireless communications and/or solar PV charging is to place antennae and/or a PV panel in a position where it will not be blocked or shadowed by other heliostats while simultaneously keeping to a minimum the blocking of sunlight from the antennae and PV panel on to its host and other heliostats.

FIG. 14 illustrates the Power Control Module (PCM) 1502 which is attached to the mirror 104 after the mirrors and support arms have been attached to the torque tube. PCM 1502 may be attached onto or near any heliostat component, it may be attached to a mirror at a position that it will not be blocked by other heliostats or block other heliostats by its movement in its daily routine movements. In order to avoid colliding with other heliostats, PCM itself may be configured to be relatively low and not protruding from the heliostat or any part protruding from it, minimizing any shadowing or hitting any neighboring heliostats. A low profile PCM may also protect it from wind or other storm damage. PCM 1502 may be in wireless communication with an Access Point (not shown) which is in turn in wireless or wired communication with a central control.

According to some embodiments, PCM 1502 may be connected or mounted to/on a PV panel 1504. The PV panel 1504 may be ideally positioned to absorb sunlight for charging batteries or any other charging means which may be inside or connected to PCM 1502. The charged means powers the heliostat which moves on a daily routine. During any 24 hour period a heliostat may track the sun during the day, position itself vertically at night and other times and may go into a protective horizontal or other positions, for example during storms, therefore the electric storage means needs to be charged sufficiently to enable movement of the heliostat to and from a stow position when there is no or little irradiance such as at night time or overcast or during a dust storm. As shown in FIG. 14, the PCM and PV panel are at the top of the mirrors where PV panel can absorb sunlight. Alternatively, the PCM and/or the batteries or other charging means can be positioned at other places such as on the pylon, for example.

As illustrated in FIG. 14, PCM antennae 1506 are at an angle between 0 and 180 degrees to the horizontal plain of the front of the mirrors 104 most preferably greater than 0 or less than 180 degrees. Each heliostat or group of heliostats may have an optimum angle for its antennae. An angle that is close to 0 or 180 degrees to the horizontal may not be in “view” of the nearest Access Point and may be hindered by a neighboring heliostat and may not be in position to receive sufficient radio frequency. As a non-limiting example, having an angle of 45 degrees or 135 degrees on the antennae would cause the PCM to be more “visible” to an Access Points as it would protrude when the heliostat was in a relatively horizontal position in relation to the ground. FIG. 14 illustrates an example of a PCM having two antennae. Alternately there may be one antenna, or three, or more antennae. When there is more than one antenna, each antenna may be at an angle of its own that is not necessarily the same angle as the other antenna of the same PCM. According to some embodiments each antenna or least one of a plurality of antennae for each PCM may move in relation to the angle of the mirror plane depending on, for example, the three dimensional position of the heliostat which changes during the day as the heliostat tracks the sun. The movement of each antenna and/or its extension may be governed by a motor which is in communication with the PCM.

As illustrated in FIG. 15, the PCM assembly 1602 may comprise a mounting bracket 1600 carrying a power control module (PCM) 1502 and a photovoltaic (PV) panel 1504 attached to the PCM.

The PCM assembly 1602 may be configured to provide instructions to the azimuth and elevation drives based at least partially on instructions provided by a separate central control (not illustrated). In addition, the PCM assembly 1602 may facilitate communication with the PCM assemblies of other heliostats, either through direct communication therewith, or via a separate Access Point (not illustrated). It is further configured to provide its own electricity, as well as electricity to power the azimuth and elevation drives.

The mounting bracket 1600 is configured for attaching the PCM assembly 1602 to the mirror assembly or any other suitable part, of the heliostats. As such, the mounting bracket may be formed having a squared U-shape, with a base for carrying the PCM 1602, and legs which may be appropriately sized so at to be received within a channel of a support arm (not shown) of the mirror assembly.

The PCM 1502 may be secured to the mounting bracket 1600 such that a front side thereof is substantially even with the base of the mounting bracket. In this way, the PV panel 1504 is substantially even with the mirror 104, thereby ensuring that the PCM assembly 1602 has a relatively low profile compared to the mirror assembly.

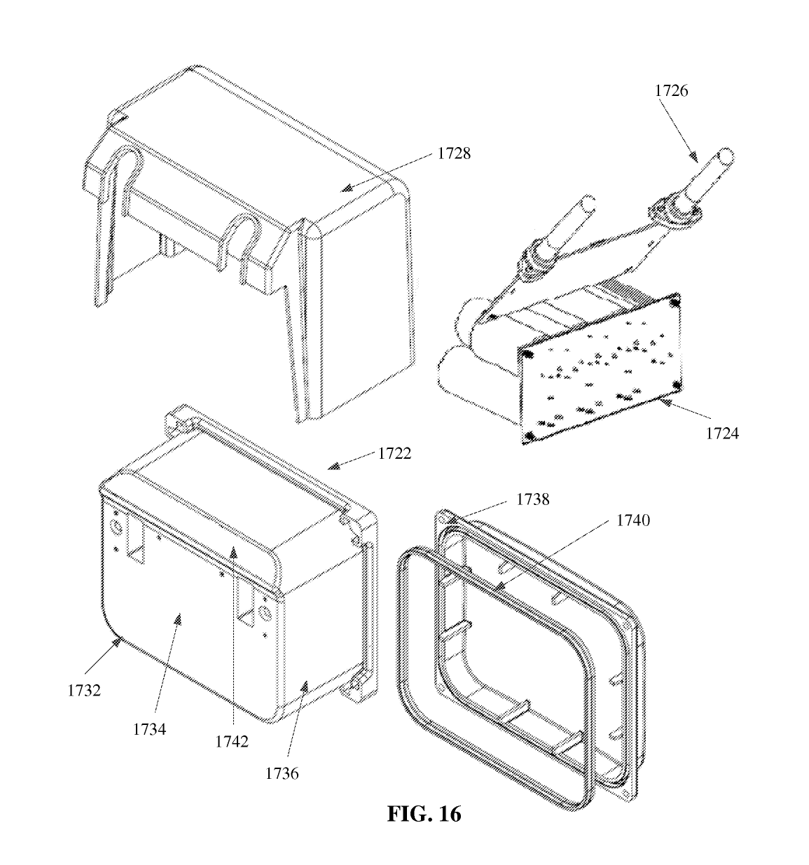

As illustrated in FIG. 16, the PCM 1502 may comprise a casing, which is generally indicated at 1722, containing electrical components 1724. Two antenna casings 1726 (shown in FIG. 16 as being mounted on antenna) are attached to the casing 1722, as will be described below. A cover 1728 is provided over the casing 1722.

The casing 1722 comprises a front 1732, which comprises a base 1734 and sidewalls 1736 and is open opposite the base thereof, and a backing 1738. The front 1732 and backing 1738 are formed so as to facilitate their assembly to a substantially closed unit. A gasket 1740 is provided between the front 1732 and backing 1738 of the casing 1722 so as to provide a seal therebetween.

The base 1734 comprises an angled surface 1742 to which the antenna cases 1726 are connected, projecting substantially perpendicularly thereto. Thus, the angle of this surface 1742 determines the angle that the antenna casings 1726 project from the PCM assembly 1602. The angle may be chosen to ensure that the antennas remain in range of a wireless Access Point, PCM assemblies of other heliostats with which it needs to communicate, and/or any other necessary wireless network device. This angle may be between 0 degrees in 180 degrees, more particularly, it may be between 45 degrees and 135 degrees. In addition, the angle may be selected so as to minimize the shadow of the antenna casings 1726 on its own PV panel 1504 and/or those of other heliostats.

Cover 1728 may be placed over casing 1722 and electrical components 1724 so as to protect the casing and components from the elements.

The electrical components 1724 of the PCM 1602 comprise a power storage array and a wireless communications array.

The power storage array comprises one or more energy storage devices, which are electrically connected to the PV panel 1504 to receive electrical power therefrom and store it. The energy storage devices may be mounted on a power circuit board which facilitates this connection, and which may comprise one or more controllers configured to manage the transfer of electrical power thereto. The energy storage devices may include one or more of super-capacitors, batteries (such as lead acid, nickel-cadmium, nickel-metal-hydride), fuel cells, and any other suitable devices. The power storage array may be in electrical communication with other elements of the PCM, as well as with elements of the heliostat (such as the azimuth and elevation drives) to provide electrical power thereto. In order to facilitate this, the power storage array may comprise one or more connectors configured to connect to cables to provide electrical energy to the azimuth and elevation drives. The controller on the power circuit board may manage this transfer of electrical energy as well. Alternatively, the power storage array may be attached to the pylon (not shown) or another place leaving the antennae and PV panel in the higher exposed positions, as described above.

The wireless communications array may comprise one or more, for example two, antennas mounted on a communications circuit board. The communications circuit board may comprise one or more controllers configured to communicate with a remote wireless network device, such as an Access Point or the PCM of another heliostat, for receiving information regarding operation of the heliostat, for example instructions for operation thereof. Based on the information it receives, the controller of the communications circuit board may issue instructions to the azimuth and elevation drives of the heliostat. Alternatively, a separate controller, physically located on the power circuit board and/or the communications circuit board (for example, the separate controller may be a single circuit element, or its function may be spread among two or more physical elements which may be located on the same or separate circuit boards) may be provided to issue instructions to the azimuth and elevation drives.

The PV panel may be configured to convert incident solar radiation to electrical energy. The PV panel may be any suitable elements known in the art. In addition, a controller, such as a charge controller or regulator, may be provided on a rear side of the PV panel. A cable is provided to transfer electrical energy produced by the PV panel to the power storage array of the PCM 1502. This electricity may be used, inter alia, to charge the power storage devices, power the wireless communications array, and/or to power the azimuth and elevation drives of the heliostat.

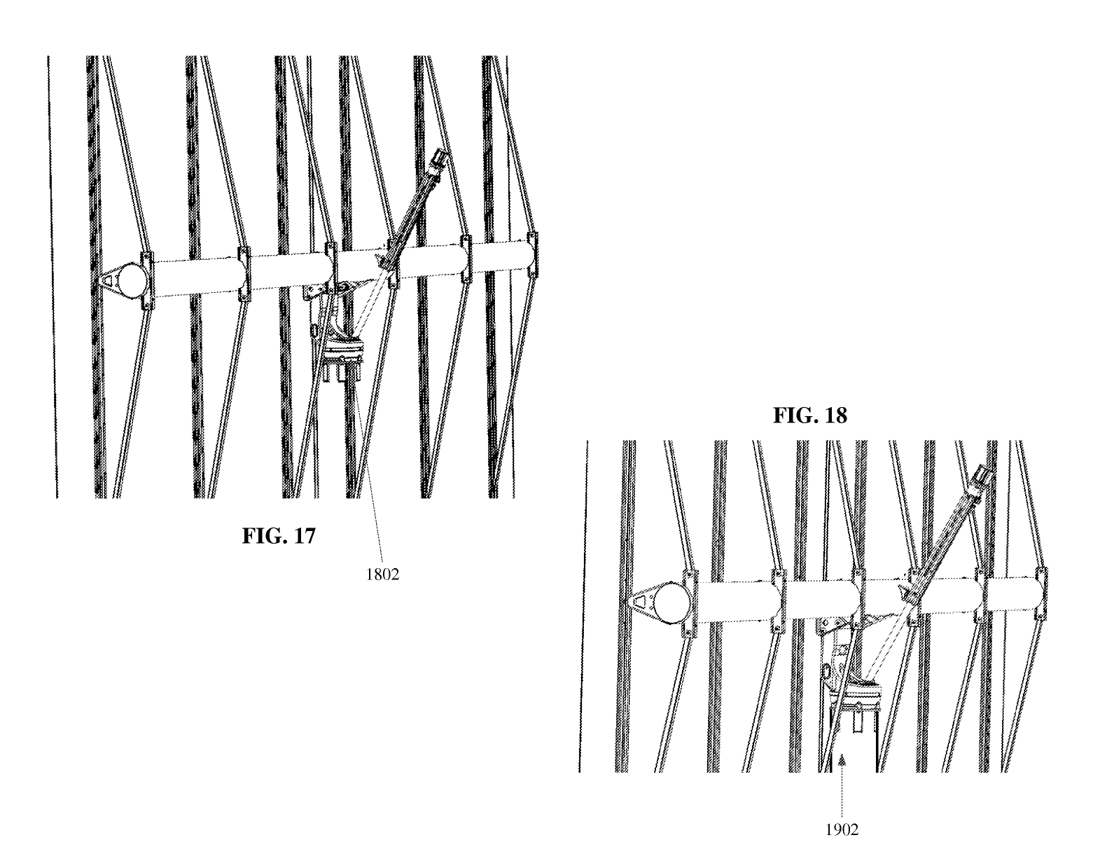

The mirror assembly and torque tube together with the azimuth drive and elevation drive, as illustrated in FIG. 17, may be connected to a pylon 1902 via an interface unit 1802 after the pylon has been inserted and anchored in the ground. FIG. 18 is an illustration of a fully assembled heliostat.

The interface unit 1802 is functionally connected to the azimuth and elevation drives, and is configured to facilitate transmission of motion provided thereby to the reflective face of the heliostats, thereby bringing about rotation thereof.

According to some embodiments, a modular sub-assembly apparatus or cell may be utilized for assembly of heliostats in close proximity to a solar field. By having a modular easily assembled assembly apparatus, the need for a complex heliostat assembly facility may be eliminated, thereby reducing labor and construction costs.

According to some embodiments, a modular heliostat assembly apparatus may be constructed within a close proximity to the solar field where pylons have been installed or are about to be installed into the ground for attaching assembled heliostats thereto. The assembly apparatus or cell 2102 may be constructed from modular elements. Each module may contain all the hardware required for assembling the electrical and mechanical parts of the heliostats. The modular elements may be designed such that its size (dimensions and weight) allow for them to be assembled from or transported as skid-mounted elements

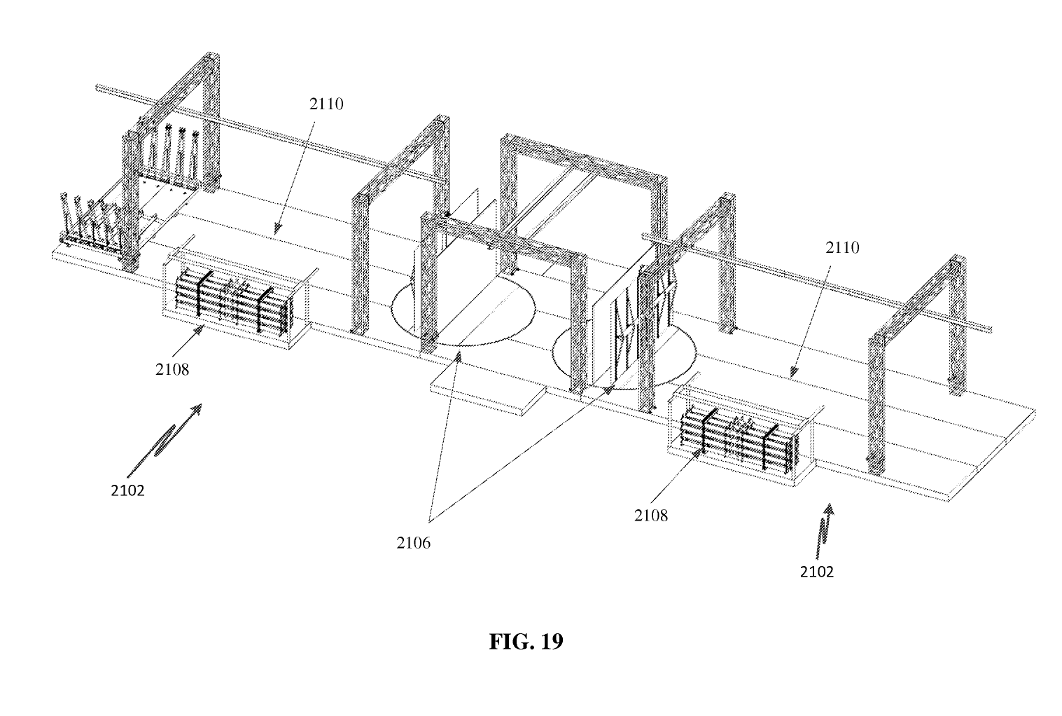

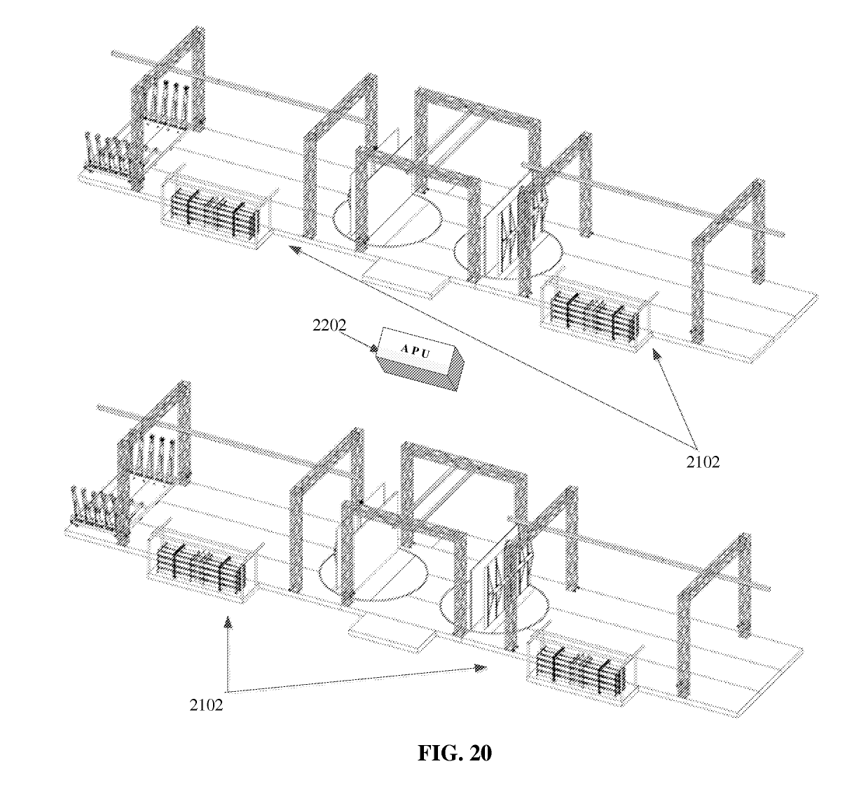

FIG. 19 illustrates a modular heliostat assembly apparatus 2102. The apparatus 2102 has a receptacle/platform 2106 for mirror assemblies, the mirror assemblies having attached at least one support arms and a pair of diagonals for each support arm attached thereon.

The apparatus 2102 may also have a receptacle 2108 for torque tube subcomponents which include torque tubes with an azimuth drive and/or an elevation drive attached thereon.

Additionally or alternatively, the apparatus may include a receptacle for torque tubes as well as an assembly station for attaching an azimuth drive and/or an elevation drive to the torque tube, creating a torque tube subcomponent. At the torque tube subcomponent assembly station the azimuth drives may be attached to torque tubes. Then an elevation drive may be attached between the azimuth drive and the torque tube as described above. The modular apparatus may also include an assembly station 2110 for attaching the torque tube subcomponent to at least one mirror, preferably two or more mirrors by means of attaching the mirror assemblies to the torque tube subcomponents, as described above. This may be performed in apparatus 2102 wherein a substantially vertical mirror loaded with adhered support arms and diagonals is attached to torque tubes. The distal ends of the diagonals are released from the support arms and, as described above, the diagonals are configured to open up only as far as U-bars allow. The top or apex of the A-plate fits into the groove of the support arms. As discussed above the exact placement of the holes determines the shape of the mirror and therefor the mirrors focal length. The A-plate may be secured to the support arm and the distal ends of the diagonals may be secured to the U-bar. The truss formed by the diagonals, U-bars A-plates and support arms are connected by any connecting means such as but not limited to pins such as grooved pins with circlips, rivets, struts, nuts and bolts and the like. A single torque tube may accommodate two mirrors. Alternatively, a torque tube may accommodate one or three or four or a greater amount of mirrors.

The modular apparatus 2102 may also include an assembly station for attaching the PCM onto the mirrors or other components of the reflection unit, as described above.

The fully assembled heliostat may be transported by a means such as a tractor or truck mounted crane, or the like, to a pylon in the solar field where the fully assembled heliostat may be attached to the pylon at the attachment points on the azimuth drive.

FIG. 20 illustrates a modular heliostat assembly apparatus with four-cells 2102 for on-site heliostat assembly. Each of the four cells may be individually supported by an Auxiliary Power Unit (APU) 2202 which provides electrical and air pressure to each of the cells. An apparatus including less or more than four cells may also be used for heliostat assembly.

Certain features of this invention may sometimes be used to advantage without a corresponding use of other features. While specific embodiments have been shown and described in detail to illustrate the application of principles of the invention, it will be understood that the invention may be embodied otherwise without departing from such principles.

It is, thus, apparent that there is provided, in accordance with the present disclosure, a heliostat and methods for the assembly thereof. Many alternatives, modifications, and variations are enabled by the present disclosure. Features of the disclosed embodiments can be combined, rearranged, omitted, etc., within the scope of the invention to produce additional embodiments. Accordingly, Applicants intend to embrace all such alternatives, modifications, equivalents, and variations that are within the spirit and scope of the present invention.

1-4. (canceled)

5. A method of assembling heliostats, said method comprising:
attaching at least one support arm to a non-reflective face of a mirror;
attaching a first end of each of a pair of diagonals to each support arm; and
folding each diagonal so as to be substantially flush with and parallel to the support arm.

6. A method of assembling heliostats according to claim 5, wherein the at least one support arm is attached to the non-reflective face of the or with an adhesive.

7. A method of assembling heliostats according to claim 5, wherein each support arm is U-shaped and each of the diagonals folds into a groove of the U-shape.

8. A method of assembling heliostats according to claim 5, wherein the diagonals are U-shaped and each of the diagonals covers at least a portion of the support m when folded down.

9. A method of assembling heliostats according to claim 5, further comprising:
attaching at least one of an azimuth drive and an elevation drive to a torque tube to form a torque tube subcomponent.

10. A method of assembling heliostats according to claim 5, further comprising:
stacking a plurality of mirrors, each having at least one support arm and respective pairs of diagonals, to form a stack having a height less than a value that is the number of stacked mirrors multiplied by the sum of the thickness of a mirror and the greater of the thicknesses of the attached support arm and of the attached pair of diagonals.

11. A method of assembling heliostats according claim 9, further comprising:
attaching the torque tube subcomponent to a second end of each of the pair of diagonals.

12. A method of assembling heliostats, comprising:
unfolding each of a pair of diagonals so as to extend outwardly from a support arm, which is attached to a non-reflective face of a mirror; and
attaching an end of each of the pair of diagonals to a torque tube or torque tube subcomponent.

13. A method of assembling heliostats according to claim 12, wherein the attaching includes securing at least one of the support arm and the end of each of the pair of diagonals to a connecting element, which is positioned to be in contact with the torque tube to form a reflection unit.

14. A method of assembling heliostats according to claim 12, wherein an attachment point of the end of each pair of diagonals defines the curvature of the mirror.

15. A method of assembling heliostats according to claim 12, wherein at least two mirrors are attached to said torque tube or torque tube subcomponent.

16. A method of assembling heliostats according to claim 12, further comprising:
attaching a power control module to the mirror.

17. A method of assembling heliostats according to claim 16, wherein the power control module is connected to a photovoltaic panel.

18. A method of assembling heliostats according to claim 13, further comprising the step of attaching the reflection unit to a pylon.

19-20. (canceled)

21. A mirror assembly for a heliostat comprising:
or with a front reflective face and a back non-reflective face;
at least two support arms attached to the non-reflective face of the mirror and having a height normal to a plane of the non-reflective face of the mirror; and
a pair of diagonals, for each of the at least two support arms, each diagonal having a respective height,
wherein a proximal end of each diagonal is attached to one of the support arms and each diagonal is configured to be folded so as to be substantially parallel with said one of the support arms;
wherein a combined height of said one of the support arms and the folded pair of diagonals is substantially the same as the greater of the height of the diagonals and the height of said one of the support arms.

22. A mirror assembly for a heliostat of claim 21, wherein the diagonals are configured to collapse into a groove of the respective support arm and the support arm height is greater than the diagonal height.

23. A mirror assembly for a heliostat of claim 21, wherein the diagonals are configured to cover the respective support arm and the diagonal height is greater than the support arm height.

24. A mirror assembly for a heliostat of claim 21, wherein a distal end of each diagonal is configured for attaching to an elongated central support element or a connecting element attached thereto.

25-29. (canceled)
